(19) United States
(12) Patent Application Publication
(10) Pub. No.: US 2021/0398110 A1
(43) Pub. Date: Dec. 23, 2021

(54) SALES PLATFORM FOR COLLECTIBLES

(71) Applicant: Tezro, LLC, Sarasota, FL (US)

(72) Inventor: Tokhir Tokhtabaev, Sarasota, FL (US)

(21) Appl. No.: 17/349,365

(22) Filed: Jun. 16, 2021

Related U.S. Application Data
(60) Provisional application No. 63/040,071, filed on Jun. 17, 2020.
(60) Provisional application No. 63/079,108, filed on Sep. 16, 2020.

(51) Int. Cl. G06Q 20/38; G06Q 40/08

(52) U.S. Cl. CPC G06Q 20/389; G06Q 30/08; G06Q 20/3821; G06Q 40/08

(57) ABSTRACT

A sales platform includes an interactive webpage or app for listing a lot for sale. A method of operating the sales platform includes registering a lot with the sales platform, recording the data associated with the lot to a blockchain associated with the sales platform, conducting a first transaction via the sales platform with the first transaction including a transfer of a stake to at least a part of the lot, and recording data associated with the first transaction to the blockchain associated with the sales platform.

### CROSS-REFERENCE TO RELATED APPLICATIONS

This patent application claims priority to U.S. Provisional Patent Application Ser. No. 63/040,071, filed on Jun. 17, 2020, and U.S. Provisional Patent Application Ser. No. 63/079,108, filed on Sep. 16, 2020, the entire disclosures of which are hereby incorporated herein by reference.

### FIELD

The present invention relates generally to a sales platform, and more particularly, to a sales platform for collectibles that can be sold in whole or in part via the use of blockchain technology.

### BACKGROUND OF THE INVENTION

Many people own collectibles/valuable items. However, an owner must sell an entirety of a collectible if the owner wants to generate income or profit therefrom. Typically, the owner must either directly sell to a buyer if one can be identified, or the owner can include the collectible in a live auction. There are expenses associated with an auction such as handling fees, holding fees, storage fees, an auctioneer commission, and the like. These expenses can be substantial.

It is therefore desirable to provide a sales platform for collectibles wherein flexibility is maximized and complexity and expenses are minimized.

### SUMMARY OF THE INVENTION

Consistent and consonant with the present invention, a sales platform for collectibles wherein flexibility is maximized and complexity and expenses are minimized, has surprisingly been discovered.

The sales platform includes an interactive webpage or app for listing lots for sale; an interface allowing input of information for a lot to be offered for sale including whether the lot is for sale as a whole or in parts; and an ecommerce portal facilitating purchase of the lots.

According to an embodiment of the present invention, a method of operating the sales platform includes registering a lot with the sales platform, recording data associated with the lot to a blockchain associated with the sales platform, conducting a first transaction via the sales platform with the first transaction including a transfer of a stake to at least a part of the lot, and recording data associated with the first transaction to the blockchain associated with the sales platform.

According to further aspects of the present invention, the lot may be a collectible, and may also be in the form of tangible property. The registering of the lot may include a seller of the lot entering an initial list price of the lot. Depending on the initial list price, the method may further include a step of evaluating the lot, wherein such evaluation may occur when the initial list price is at or above an evaluation threshold value. The evaluating of the lot may be performed by a comparative pricing expert. Alternatively, the method may further include a step of insuring the lot when the initial list price is at or above an insurance threshold value. When insurance is required, the step of registering the lot may include submitting a proof of insurance of the lot to the sales platform. The step of recording data associated with the first transaction may include converting a value of the stake to at least a part of the lot to a digital token associated with the sales platform.

The stake to at least part of the lot may be a minority stake to the lot, and a seller of the minority stake in the lot may maintain a majority stake in the lot following completion of the first transaction. Alternatively, the stake to at least part of the lot may be an entire stake in the lot. The method may further include a step of transferring physical possession of the lot following the conducting of the first transaction when the entire stake in the lot is transferred.

The method may further include the conducting of additional transactions with respect to the stake in at least part of the lot. The method may include additional steps of: conducting a second transaction via the sales platform, the second transaction including a transfer of the stake to at least the part of the lot transferred during the first transaction, and recording data associated with the second transaction to the blockchain associated with the sales platform. The second transaction may occur with respect to a minority stake in the lot.

### BRIEF DESCRIPTION OF THE DRAWINGS

The above-mentioned, and other features and objects of the inventions, and the manner of attaining them will become more apparent and the invention itself will be better understood by reference to the following description of an embodiment of the invention taken in conjunction with the accompanying drawings, wherein:

FIG. 1 is a flow chart showing a method of operating a sales platform according to an embodiment of the present invention;

FIGS. 2 and 3 each show an exemplary graphical interface of a mobile application or web page used to interact with the sales platform according to the method of FIG. 1.

### DETAILED DESCRIPTION OF THE INVENTION

The following detailed description and appended drawings describe and illustrate various exemplary embodiments of the invention. The description and drawings serve to enable one skilled in the art to make, and use the invention, and are not intended to limit the scope of the invention in any manner. With respect to the methods disclosed, the steps presented are exemplary in nature, and thus, the order of the steps is not necessary or critical.

The present invention generally relates to a sales platform utilizing blockchain technology for carrying out an online auction. Although certain exemplary transactions are disclosed in detail herein, it should be apparent that the disclosed systems and methods may be adapted to other related transactions associated with different exchanges, goods, or services than those specifically discussed herein. Any examples provided herein regarding the sale or exchange of consumer goods or collectibles may similarly be adapted to apply to the sale of other forms of property or to the creation of other contractual obligations without necessarily departing from the scope of the present invention.

Although examples regarding the sale of collectibles are described in detail herein, the disclosed sales platform may be used for any type of sale or exchange, and is not limited to collectibles. As used hereinafter, a lot is defined as any valuable item sold via the sales platform. The lot may be in the form of tangible property. The lot may be considered a collectible. Persons and entities having a right to place a lot for sale utilizing the sales platform include galleries, museums, auction houses, financial organizations, banks, collectors, private owners, retail stores, distributors, warehouses, and the like, as non-limiting examples. As used hereinafter, a right to resell a lot refers to a right granted to a buyer of a lot (or a part of a lot) only when the lot (or part thereof) was purchased and paid for in full in a manner satisfying all associated terms and obligations.

The sales platform may be presented as a website or a mobile application responsible for hosting the auction processes as described hereinafter. As should be understood, a smart device such as a laptop computer, a smart phone, a smart tablet, or the like may be utilized by a user in order to access the sales platform. The smart device may be any device having a user interface and the ability to communicate data to and from the smart device, including the use of the internet to facilitate the communication of data between individual users of the sales platform. The user interface may refer to a graphical interface such as a touch-screen display, a keyboard, a mouse, or the like, depending on the type of smart device utilized. Each smart device associated with operation of the sales platform may include a processor and a non-transitory computer-readable medium operably coupled to the processor, wherein the non-transitory computer-readable medium has instructions stored thereon that when executed by the processor cause the computing device to implement a method of carrying out a transaction according to the present invention in accordance with those actions described hereinafter as being performed by a user of the sales platform. Such instructions may be associated with a mobile application stored to a memory of the corresponding smart device or with a web browser accessing a website acting as the sales platform, as desired.

The sales platform may also be associated with at least one computing device having a processor and a non-transitory computer-readable medium operably coupled to the processor, wherein the non-transitory computer-readable medium has stored thereon instructions that when executed by the processor cause the computing device to implement a method of carrying out a transaction according to the present invention and in accordance with those actions described hereinafter as being performed by the sales platform in reaction to an action by a user thereof. The at least one computing device associated with the sales platform may refer to any number of interconnected computing systems carrying out the processes described hereinafter, as desired.

As used herein, a user of the sales platform is any person or any entity participating in a transaction initiated by the sales platform and including the transfer of the rights to a lot or a part of a lot (hereinafter a “partial lot”) through use of the sales platform. An account holder is a user who has established an account through the sales platform. The account may include information regarding the lots or partial lots in the possession of the account holder. The account may also be associated with a digital wallet that reflects the wealth of the account holder in terms of tokens created by the sales platform and representative of lot or partial lots available for purchase via the sales platform. An insurance agent or insurance broker refers to an entity that is responsible to insure digital funds that are utilized by the sales platform in carrying out an auction process.

The sales platform may be based on a technological, decentralized EOS platform, which generally revolves around the use of tokens, such as those described above as being represented within a digital wallet of an account holder. The sales platform may utilize the Delegated Proof of Collision Algorithm (DPOS), which allows for the handling of millions of users and millions of transactions utilizing blockchain technology. Blockchain represents transactions that users make during use of the sales platform and the corresponding sales platform. The system blockchain produces blocks every 3 seconds. Exactly one manufacturer is entitled to produce a block at any given time. If the block is not created at the scheduled time, the block is skipped. Blocks are produced in 21 rounds. At the start of each round, 21 unique block producers are selected. In each round, the top 20 candidates are automatically selected, and the last manufacturer is selected in proportion to the number of votes compared to other manufacturers having access to the system. The selected manufacturers are shuffled using a random number (pseudo-randomness derived from block time). This shuffling ensures that all manufacturers maintain a balanced relationship with all other manufacturers.

However, the present invention is not limited to the use of the above-described EOS platform when recording data regarding the transactions of the sales platform. It should be apparent to one skilled in the art that the transactions taking place through use of the sales platform may be carried out and recorded using any decentralized blockchain system forming a publicly distributed ledger of the transactions carried out via the sales platform while remaining within the scope of the present invention. The sales platform may be associated with any blockchain-based network having the capability to perform the tasks described hereinafter.

The sales platform is configured to perform payments and other internal transactions among the users thereof. A user first creates an account with the sales platform, which establishes an internal digital wallet associated with the account. The user is then considered an account holder. The account holder then transfers a desired amount of a crypto currency or fiat currency to the sales platform for placement within the wallet. The transferred amount of the crypto or fiat currency is converted to a corresponding amount of tokens associated specifically with the sales platform. The tokens may be created as internal EOS assets in the same quantity and in the same denomination as the originally transferred crypto or fiat currency. The tokens may be created as a result of the work of internal smart contracts associated with operation of the sales platform.

Transactions carried through the sales platform may include the transfer or exchange of the created tokens between the accounts of the different users of the sales platform. The transfer or exchange of these tokens allows the transactions to be beneficially performed in a matter of milliseconds without geographic limitations. The transactions are also able to be beneficially carried out in the absence of a bank or other intervening financial organization.

If an account holder would like to remove currency from the sales platform, the account holder indicates from which account wallet the tokens should be withdrawn and to which external account the tokens should be transferred. The sales platform then writes off the tokens, which may be in the form of the EOS assets, of the specified type of currency (crypto or fiat) in the amount specified by the account holder. The corresponding amount of the currency is then credited to the external account as specified by the account holder.

As used hereinafter, the account holders of the sales platform may be referred to as buyers or sellers, depending on the role instantaneously being played by the corresponding account holder with respect to a transaction carried out using the sales platform. As is established hereinafter, an account holder acting as a buyer may later become a seller once a right to resell the lot has been established with respect to the initial buyer. It should accordingly be apparent that such labels are fluid and dependent on the specific circumstances of each transaction carried out by the sales platform.

The sales platform according to the present invention beneficially allows users thereof to purchase a partial lot or the entirety of a lot. As used hereinafter, a whole lot or an entirety of a lot refers to a 100% ownership stake in the corresponding lot. A user having the whole lot may be referred to as an owner of the lot, wherein the owner of the lot may also have physical possession of the lot. A majority stake in a lot refers to an ownership stake of greater than 50% in the corresponding lot. A user having a majority stake in a lot may be referred to as a majority stakeholder in the corresponding lot, and the stake owned by the majority stakeholder may be referred to as a majority partial lot. In contrast, a minority stake in a lot refers to an ownership stake of less than a 50% in the corresponding lot. A user having a minority stake in a lot may be referred to as a minority stakeholder in the corresponding lot, and the stake owned by the minority stakeholder may be referred to as a minority partial lot.

In some circumstances, the sales platform may be utilized to sell an entirety of the lot (100% ownership stake) to a single buyer. In such circumstances, the entire value of the lot is transferred from the seller to the buyer, and a transfer of physical possession of the lot may be facilitated as a condition of this sale. This transfer of physical possession may be performed according to terms and conditions of the sale of the lot.

In other circumstances, the sales platform may be utilized to divide the lot into the above described partial lots, wherein each of these partial lots is then available for purchase independently via use of the sales platform. The sales platform accordingly allows a seller to receive proceeds from the sale of a partial lot without having to transfer physical possession of the lot. The seller can also maintain an ownership stake in the lot following the transfer of the partial lot, thereby allowing for the seller to maintain some investment in the lot. The sales platform also allows for minority stakeholders in a lot to invest in the corresponding minority partial lots without having to purchase the entirety of the lot. The minority stakeholders can also beneficially avoid the need to take physical possession of the lot upon the purchase of a minority partial lot.

The owner of an entire lot acting as a seller initially determines whether the lot is to be available for purchase in whole or in discrete parts when registering the lot with the sales platform. The sales platform may be configured to restrict how a lot can be divided and sold via the sales platform. For example, if the lot is divided into partial lots (as opposed to being sold as a whole), the sales platform may require that the original owner maintain at least a 50% ownership stake in the lot being offered for purchase. Stated otherwise, the sales platform may include a restriction wherein a sum total of all minority partial lots is always less than a 50% ownership stake in the lot. As such, the division of any lot will always result in the formation of a majority partial lot corresponding to a majority stake in the lot and at least one minority partial lot corresponding to a minority stake in the lot. This restriction may also be maintained following the initial division of the lot. As such, a majority partial lot corresponding to a majority stake in the lot may not be subdivided and converted to multiple minority partial lots for a future transaction. This restriction may be applied to avoid a situation where no single user has a majority stake in the lot.

For example, an owner making a lot available for purchase may choose to maintain a 51% stake in the lot and may offer the remaining 49% ownership stake in the form of 49 discrete and independently sold parts each associated with a 1% ownership stake in the lot. The lot is accordingly divided into 50 discrete parts that can be sold independently. This restriction leads to a condition wherein the minority stakeholders cannot collectively achieve a majority stake in the lot via the purchase of the 49 parts having the 1% ownership stake. This restriction accordingly prevents a circumstance wherein multiple minority stakeholders have a combined ownership stake of greater than 50%, as such an occurrence could present conflicts regarding physical possession of the lot or future determinations regarding a reselling of the lot.

The sales platform may also be configured to place restrictions on the division of a lot based on the value of the lot. For example, the sales platform may be configured to require that any lot having a value under a threshold value be sold as a whole lot, as opposed to the lot being divided into a majority lot and at least one minority lot. This threshold value may be $5,000, as one non-limiting example. However, the sales platform may operate without such restrictions.

Lastly, the sales platform may also be configured to restrict the division of the lot into discrete units having set stake percentages associated therewith. For example, the sale platform may require each lot be divided into lot parts that constitute whole percentage points of ownership stake in the lot, such as requiring that minority ownership stakes be provided as multiples of 1% of the value of the lot, such as a 1% stake, a 2% stake, and so on. However, the sales platform may still operate according to the method of the present invention absent such restrictions.

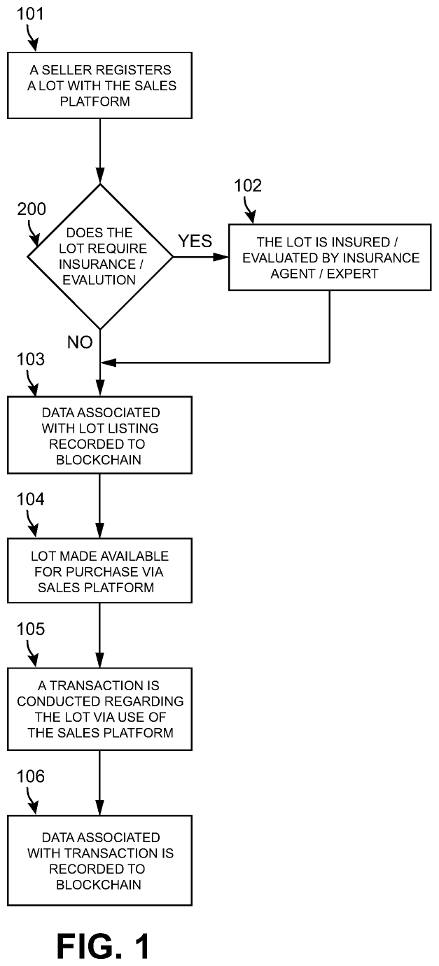

Referring now to FIG. 1, a method of operation of the sales platform is disclosed. The sale of the lots or the partial lots is described hereinafter as an auction process, but it should be apparent to one skilled in the art that the sales platform may be utilized for performing any type of transfer of property rights in addition to an auction process while remaining within the scope of the present invention. For example, rather than an auction process, the lot or the partials lots may be made available for purchase at a set price in the absence of any type of bidding or negotiating process. Future references to placing or putting the lot or partial lots up for auction may therefore refer to or otherwise be associated with any method of making the lot or partial lots available for purchase via the sales platform, and does not necessarily limit the present invention to bidding processes or the like that may traditionally be considered auction processes.

In the present example, the auction process is shown as may be performed by the sales platform described herein wherein EOS assets in the form of tokens are used to represent the value of each lot or each discrete part of a divided lot. However, it should be understood that other blockchain technologies or systems may be utilized according to the method of the present invention, hence references to the EOS assets in the form of tokens is considered to be non-limiting. The disclosed method of operation of the sales platform also assumes that each of the users described hereinafter is an account holder having access to each of the features of the sales platform, including the necessary funds/tokens present within each of the digital wallets associated with each of the users taking part in the transaction.

The method according to the present invention includes a step 101 of initially registering the lot with the sales platform. The registering of the lot with the sales platform may include the owner/seller of the lot providing certain data about the lot to the sales platform. This data can then be used to establish a listing of the lot and/or the partial lots thereof on the sales platform. The registering of the lot on the sales platform may be subject to certain restrictions as set forth hereinafter.

The data associated with the lot can also be used to record information associated with the lot to a blockchain associated with the sales platform, thereby creating a record of the lot and any data associated therewith on a distributed ledger available for inspection by any user of the sales platform, all of which have access to the blockchain and the records thereof. As should be understood, references to data being recorded on a blockchain refers to such data being communicated to and stored at a plurality of different nodes participating in the creation and/or maintenance of the blockchain, wherein each of these nodes may include a memory that is a form of non-transitory computer-readable medium for storing the records of the blockchain.

The sales platform as described herein accordingly forms an interface for accessing the data contained within the blockchain. The sales platform may be in communication with the nodes participating in the creation/maintenance of the blockchain, wherein any data communicated to the sales platform via the selection of a user may be communicated to the nodes for creating a new entry/record/block, or wherein any data recorded within the blockchain may be found and retrieved from the blockchain for display to a user via the sales platform. As such, references hereinafter to data being communicated between the sales platform and the blockchain refers to data being communicated, such as by the internet, between the at least one computing device hosting the sales platform and any nodes responsible for the creation/maintenance of the blockchain.

The data associated with the registering of the lot may include the name of the product/item/collectible/property available for purchase, a detailed written description of the lot, and an initial desired price of the lot. The registering of the lot may also include the entry of data associated with whether and how the lot is to be divided into the different partial lots, as applicable. For example, the owner of the lot may select a desired majority stake to maintain as a majority partial lot and then determine how to divide the remaining minority stake of less than 50% to be offered for purchase as one or more minority partial lots. The sales platform may require that a specific number of photographs or other identifying information regarding the lot be uploaded by the owner as a requirement of the registration process.

As indicated by decision block 200, the registering of the lot may include the lot requiring insurance or additional evaluation/authentication before the lot can be fully registered and listed on the sales platform and made available for purchase by prospective buyers. The sales platform may be configured to place various different restrictions on the lot that trigger the need for additional insurance and/or evaluation/authentication. For example, in some circumstances, certain types of classes of lots may require that certain authentication documents or other records be submitted as part of the data associated with the registering of the lot. Certain documents that can validate the value of the lot may also be required to ensure that the lot is an original and not a copy.

In other circumstances, the suggested price of a lot may trigger the need for additional steps to be taken, such as a step 102 of insuring or evaluating the lot. For example, if the lot is initially listed at a price at or above an evaluation threshold value, then the sales platform may require that the lot be reviewed by a comparative pricing expert or the like to ensure the value of the lot is in accordance with the requested sales price. This evaluation threshold value may be $50,000, as a non-limiting example. As another example, if the lot is initially listed at a price at or above an insurance threshold value, then the sales platform may require that the lot be reviewed and insured by an insurance broker or insurance agent. A proof of insurance may be required to be submitted during the registering of the lot when such a requirement is triggered by the suggested sale price of the lot. The sales platform may also require that the lot is insured to the initial suggested sales price of the lot (as set by the seller). In some circumstances, the sales platform may require that seller fully pays out the initial suggested sales price of the lot to account for unexpected events that may cause the loss of the lot.

Once the lot has been fully registered, meaning that all necessary data has been entered and all required insurance/evaluation/authentication has taken place in accordance with the requirements of the sales platform, the method according to the present invention may include a step 103 of recording the data associated with the lot listing as an entry into a blockchain associated with the sales platform. Some or all of the data entered with respect to the lot may be recorded to the blockchain, as desired. The data recorded to the blockchain may at least include data identifying the lot or partial lot and any data associated with the terms of a transaction occurring with respect to the lot or partial lot, such as the agreed upon sales price. The data entered into the sales platform may first require conversion to a form best suited for recordation in the blockchain. Each lot listing may be associated with a unique identifier with all future transactions related to that lot also associated with the unique identifier.

The recordation of the lot data into the blockchain may include a conversion of the determined value of each part of the lot into a corresponding value of the digital tokens as described hereinabove with respect to the EOS platform. That is, depending on whether and how the lot is divided, each lot or partial lot is associated with a corresponding value of such tokens based on a value of the lot, wherein such tokens are readily and easily transferred between account holders of the sales platform. Such tokens are also able to be tracked via the corresponding blockchain associated with the sales platform, hence each lot or partial lot is able to be tracked within the blockchain in the event that such lots or partial lots are transferred again in a future transaction. The conversion of each lot or partial lot to a corresponding set of tokens accordingly facilitates the transfer of such ownership stakes between the account holders of the sales platform while also providing a means to track each subsequent transaction regarding any minority partial lots.

As indicated in step 104, the lot or partial lots are then made available for purchase on the sales platform, wherein the step 104 may include listing the lot or partial lots for bidding via an auction process hosted on the sales platform. More specifically, the sales platform may utilize a double non-stop auction, where the requests of account holders acting as either buyers or sellers are met with maximum similarity of price during a selling or a purchasing of a lot or partial lots. A double auction is a process of buying and selling goods with multiple sellers and multiple buyers, wherein requests can be made by sellers as well as by buyers. Potential buyers submit their bids, and potential sellers submit their asking prices to the sales platform. The sales platform is configured to present the sales requests to the prospective buyers in list form and to present the purchase requests to the prospective sellers in list form. The listed requests may be visually displayed with the data relating to the desired transaction, including the sale/purchase price and/or information relating to the lot or partial lot being sold.

The sales platform performing the double non-stop auction may be configured to present the purchase requests or the sales requests to an account holder in a specified order to facilitate achieving the similarity of the prices between a seller and a buyer. For example, if a buyer has a particular price in mind for a particular product sold as a lot or partial lot on the sales platform, the sales platform may be configured to present a listing of related sales requests in an ascending or descending price order relative to this selected price. The buyer can accordingly find a sales request from one of the sellers that requests a price that is most similar to the price the buyer is willing to pay. Similarly, if a seller has a particular price in mind for selling a lot or partial lot, then the sales platform may be configured to present a listing of related purchase requests in an ascending or descending price order relative to this selected price. As yet another example, the sales platform may be configured to present sales or purchase requests that fall within a range including the desired sales price or purchase price, such that prices similar to the desired price are listed with respect to both higher and lower prices than that desired by the corresponding buyer/seller. The sales platform may include a feature wherein the corresponding account holder can select such parameters, including sorting the requested sales prices or requested purchase requests in any desired order or via any data associated therewith, to aid in creating such a match in price requests or a match in similarity of the lots being compared.

As one non-limiting example regarding the sorting of the sales requests and the purchase requests, if an account holder acting as a buyer has a particular purchase price in mind, then the sales platform may present only those sales requests of the same or of a greater value. In contrast, if an account holder acting as a seller has a particular sales price in mind, then the sales platform may present only those sales requests of the same or of a lower value. However, any sorting process may take place with respect to the sales requests and the purchase requests while remaining within the scope of the present invention.

The participants in an auction facilitated by the sales platform may be limited to those account holders having the requisite funds within their respective wallets to purchase the lot or partial lot in question, wherein the wallet balance is established by the sale platform. Additionally, it may be required that a separate entity such as the KYC system be used to verify participants.

Regardless of the method of sale, a step 105 includes the conducting of a transaction via the sales platform. The transaction includes a transfer of a right to at least a part of the lot between the seller and the buyer. The transaction is completed when a sale price is agreed upon between the seller and the buyer with respect to the corresponding lot or partial lot, as may occur during the above described auction process. If the entire lot is for sale, the transaction may include the transfer of all rights to the lot, including the need for a transfer of physical possession of the lot, in exchange for an agreed upon amount of a specified currency. If only a minority partial lot is for sale, an ownership right to a partial lot may be transferred from the seller to the buyer in exchange for an agreed upon amount of a specified currency. However, other forms of compensation may be contemplated for exchange via the sales platform while remaining within the scope of the present invention.

According to a step 106, the data associated with the transaction is recorded to the blockchain associated with the sales platform. Regardless of the manner in which the lot or partial lot is made available for purchase, a transaction regarding a lot or partial lot is considered to be completed when a seller and a buyer agree upon a purchase price for the corresponding lot or partial lot. The step 106 may include the transfer of the proceeds from the sale of the lot or partial lot from the buyer to the seller as a result of the recordation of the transaction to the blockchain. For example, a corresponding number of the tokens may be transferred from the wallet of the buyer to the wallet of the seller in similar fashion to that described hereinabove to represent the transfer in value associated with the transfer in the property rights to the lot or partial lot in exchange for the purchase price of the lot or partial lot. The buyer of a lot or partial lot may receive a blockchain certificate and tokens representing the lot or partial lot purchased. The data communicated to the blockchain allows for the lot, any partial lots, and any tokens associated with the transaction to be easily tracked and inspected via review of the data recorded within the blockchain upon the completion of future transactions with respect to the lot or the partial lots. As mentioned above, all relevant data regarding all transactions performed via the sales platform is available for public inspection via access to the blockchain.

Following the sale of a minority partial lot, the rights to the associated lot are divided between multiple account holders including the majority stakeholder and each of the minority stakeholders. The sales platform is configured to allow for any minority stakeholder to resell his or her minority partial lot following completion of the purchase of the minority partial lot. Such a reselling process may be similar to the process disclosed in FIG. 1, except certain data regarding the minority partial lot may not be required to be entered by the seller, including data regarding the authenticity or insurance status of the partial lot that was established during the initial registering of the lot. Specifically, the step 101, the decision block 102, and the step 103 may be replaced with a single step wherein the seller of the minority partial lot indicates the desire to post or list the minority partial lot for resale on the sales platform. The remainder of the process may then remain the same, wherein the steps 104, 105, and 106 take place as described to agree upon a price, complete a transaction, and record all relevant data of the transaction to the blockchain associated with the sales platform.

An entire lot may also be resold on the sales platform. The process to resell the entire lot may be identical to that described above with respect to the minority partial lot, wherein certain authentication or insurance data may be omitted by virtue of the prior registering of the entire lot. In other circumstances, the sales platform may be configured to require a reregistering of the lot following the sale of the entirety thereof as a means to reevaluate the lot following the passage of time or the transfer in physical possession of the lot. This process can occur as described herein with respect to the steps described in FIG. 1. If a seller chooses to sell the entire lot, the sales platform may be configured to require that the seller notify all participants in an associated auction process a selected time period before the sale, such as 10 days, as one non-limiting example.

As a final circumstance, the majority stakeholder may choose to sell the majority stake in the lot while other minority partial lots are still owned by one or more minority stakeholders. In case of the buyout of the majority stake, the remaining minority partial lots may be bought based on a market value of the lot at the moment of the sale.

The sales platform may generate a profit by subjecting the described transactions to various fees. For example, a percentage of each transfer of funds may be applied as a fee to be paid to the sales platform. Fixed fees may also be utilized, as desired. Required support for the sales platform, as well as any commissions from sales, are accordingly substantially lower than other systems or methods for conducting auctions due to the elimination of various physical restraints.

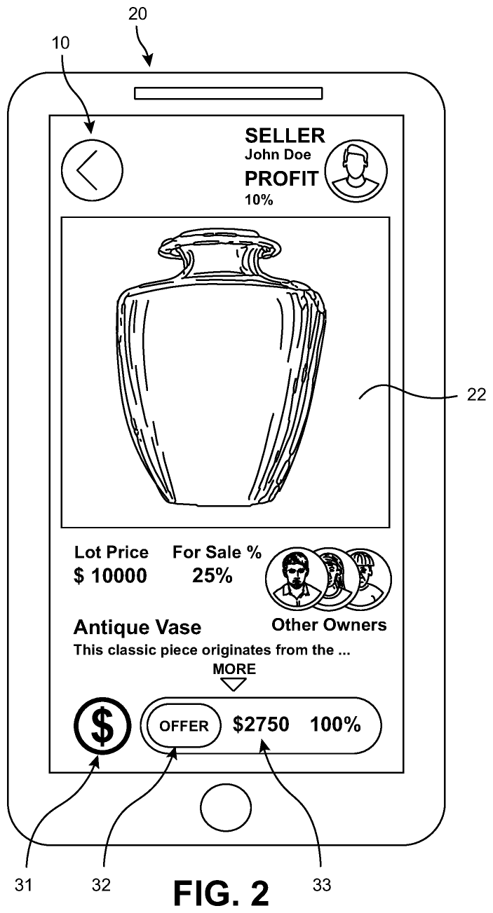

Referring to FIG. 2, an exemplary graphical interface 10 of the sales platform is shown as displayed on a touch screen display 22 of a smart device 20. The graphical interface 10 is configured to display data regarding the lot listing, such as photographs of the lot, the lot price, etc. The graphical interface 10 also includes a plurality of interactive areas displayed thereon, wherein each of the interactive areas corresponds to a portion of the touch screen display 22 with which a user when interact when attempting to navigate the sales platform or enter data regarding the registering or sale of a lot and/or partial lot. In the case of a touch screen display 22, each of the interactive areas may correspond to a graphical depiction of text, images, symbols, or other visual identifiers as displayed on the touch screen display 22, wherein a touching or other interaction with the touch screen display 22 initiates the selection of one of the interactive areas.

FIG. 2 shows the graphical interface 10 as displaying a product review page with respect to an exemplary lot. More specifically, the product review page is shown in a configuration wherein a buyer is attempting to make an offer for purchase of a minority partial lot of the exemplary lot. The graphical interface 10 communicates information such as the seller (John Doe), the expected profit of the offer (10%), the price of the whole lot ($10,000), the percentage stake of the lot for sale as the minority partial lot (25%), a listing of other account holders owning at least a minority partial lot of the lot, a name of the lot (antique vase), and a description of the lot. The interactive areas include an interactive area 31 for choosing a type of currency to be used in completing the transaction (such as different types of cryptocurrency) and an interactive area 32 for choosing an action to take with respect to the lot or partial lot (such as “buy,” “sell,” or the illustrated “offer”). An interactive area 33 allows for the buyer (which corresponds to the user viewing the graphical interface 10 of FIG. 2) to select the desired purchase price, which in the present case represents the price offered for the purchase of the 25% ownership stake in the lot (due to the “offer” interactive area 32 being selected). The graphical interface 10 further communicates that the offer of $2750 is for 100% of the value offered by the seller, which in this example refers to the entirety of the 25% ownership stake in the lot. The graphical interface 10 as shown in FIG. 2 accordingly facilitates the bidding/negotiating/purchasing of a desired lot or partial lot in accordance with the method of the present invention.

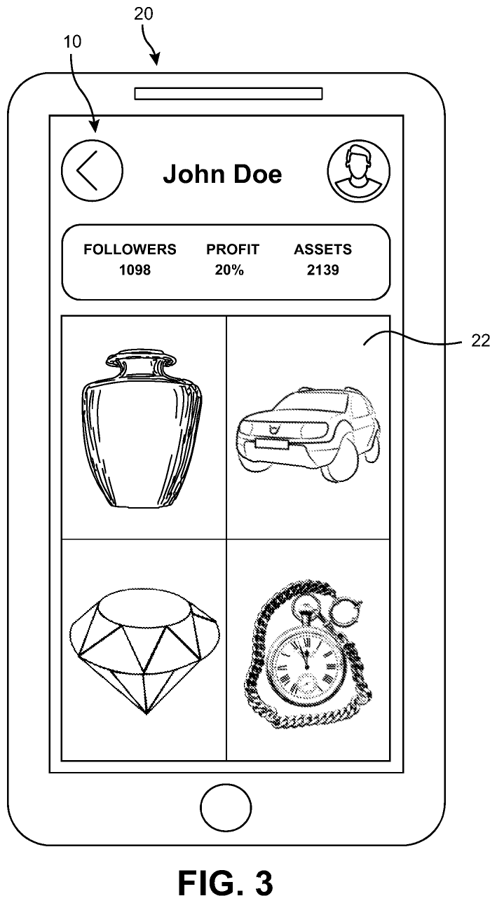

The sales platform further allows for a user thereof to review the wealth portfolio of any account holders participating in any transactions via the sales platform. For example, FIG. 3 shows a seller's profile page for showing the details related to a seller of a lot through the sales platform, wherein the seller's profile page is once again displayed on a graphical interface 10 of a smart device 20, such as the touch screen display 22. The seller's profile page includes graphical representations indicating such information as the identity of the seller, the number of followers of the seller, the profit to date of the seller, the total wealth of the seller in the tokens utilized by the sales platform, and a visual representation of the wealth of the seller through photos of the different lots or partial lots owned by the seller. The sales platform accordingly allows for the review of a variety of information about each account holder that may aid in facilitating further transactions or the like.

FIGS. 2 and 3 illustrate the manner in which the sales platform facilitates the conducting of transactions through the sales platform via easy to navigate graphical interfaces 10 communicating all data necessary for buyers and sellers to confidently make a transaction via the sales platform. The sales platform also provides a means to easily visually inspect the data recorded to the associated blockchain via the communication of such data in an organized format.

The sales platform and method of operating the same as described herein provides numerous advantageous features. The sales and lot information is visible and transparent via use of the sales platform, and is made available through the blockchain. Information such a quantity of the lots/partial lots sold and the percentage that the owner holds in each lot/partial lot is also visible and available for public inspection. One can also resell or track a desired lot or partial lot in the blockchain, which prevents others from changing or breaking into the records.

The sales platform also beneficially allows individuals to purchase a part in a valuable collectible item such as antique pieces, art, precious jewelry, and the like, for example. An owner of each collectible item that has the item in their possession has an opportunity to generate a profit due to an increase in the value of the item. At the same time, part owners of the collectible item have an opportunity to make a profit if the item sells at a higher price to another individual.

In summary, the sales platform is constructed in a way that allows all the lots to be numbered and saved/recorded in a blockchain. The sales platform accordingly replaces old, outdated, and costly physical auction systems. The sales platform is developed based on new blockchain technologies, where all the components are automated and deal expenses are minimized. The sales platform forms an e-commerce portal that is in communication with a blockchain, thereby appreciating the benefits of a graphical interface and a permanent and distributed record keeping system.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A method of operating a sales platform comprising the steps of:
registering a lot with the sales platform, the registering of the lot including an entry of data associated with the lot;
recording the data associated with the lot to a blockchain associated with the sales platform;
conducting a first transaction via the sales platform, the first transaction including a transfer of a stake to at least a part of the lot; and
recording data associated with the first transaction to the blockchain associated with the sales platform.

2. The method of claim 1, wherein the lot is a collectible.

3. The method of claim 2, wherein the lot is tangible property.

4. The method of claim 1, wherein the registering of the lot includes a seller of the lot entering an initial list price of the lot.

5. The method of claim 4, further comprising a step of evaluating the lot when the initial list price is at or above an evaluation threshold value.

6. The method of claim 5, wherein the evaluating is performed by a comparative pricing expert.

7. The method of claim 4, further comprising a step of insuring the lot when the initial list price is at or above an insurance threshold value.

8. The method of claim 7, wherein the step of registering the lot includes submitting a proof of insurance of the lot.

9. The method of claim 1, wherein the step of recording data associated with the first transaction includes converting a value of the stake to at least a part of the lot to a digital token associated with the sales platform.

10. The method of claim 1, wherein the stake to at least part of the lot comprises a minority stake to the lot.

11. The method of claim 10, wherein a seller of the minority stake in the lot maintains a majority stake in the lot following completion of the first transaction.

12. The method of claim 1, wherein the stake to at least part of the lot comprises an entire stake in the lot.

13. The method of claim 12, further comprising a step of transferring physical possession of the lot following the conducting of the first transaction.

14. The method of claim 1, further comprising the steps of:
conducting a second transaction via the sales platform, the second transaction including a transfer of the stake to at least the part of the lot transferred during the first transaction; and
recording data associated with the second transaction to the blockchain associated with the sales platform

15. The method of claim 14, wherein the stake to at least the part of the lot is a minority stake in the lot.
